(19) United States
(12) Patent Application Publication
(10) Pub. No.: US 2008/0280210 A1
(43) Pub. Date: Nov. 13, 2008

(54) NON-AQUEOUS ELECTROLYTIC SOLUTION SECONDARY BATTERY AND NON-AQUEOUS ELECTROLYTIC SOLUTION

(75) Inventor: Atsumichi Kawashima, Fukushima (JP)

Correspondence Address: BELL, BOYD & LLOYD, LLP, P. O. BOX 1135, CHICAGO, IL, 60690, US

(73) Assignee: SONY CORPORATION, Tokyo (JP)

(21) Appl. No.: 12/116,678

(22) Filed: May 7, 2008

(30) Foreign Application Priority Data
May 8, 2007 (JP) 2007-123484
Jun. 29, 2007 (JP) 2007-172720

(51) Int. Cl. H01M 6/16; H01M 6/04

(52) U.S. Cl. 429/324; 429/199

(57) ABSTRACT

A non-aqueous electrolytic solution secondary battery includes a positive electrode, a negative electrode and a non-aqueous electrolytic solution, wherein the non-aqueous electrolytic solution contains a halide of an element selected from the group consisting of Zr and elements belongings to the Group 5, the Group 6 and the Groups 12 to 15 of the Periodic Table.

### CROSS REFERENCES TO RELATED APPLICATIONS

The present application claims priority to Japanese Patent Application JP 2007-123484 and Japanese Patent Application JP 2007-172720 filed in the Japan Patent Office on May 8, 2007 and Jun. 29, 2007, respectively, the entire contents of which being incorporated herein by reference.

### BACKGROUND

The present application relates to a non-aqueous electrolytic solution secondary battery with reduced expansion under a high-temperature atmosphere while keeping good a cycle characteristic.

In recent years, a number of portable electronic devices such as camcorders, digital still cameras, cellular phones, personal digital assistants and notebook computers, each achieving a reduction in size and weight, have appeared. Batteries, in particular, secondary batteries have been receiving attention as a portable power source for such electronic devices, and intensive studies have been conducted for the purpose of enhancing the energy density. Above all, lithium ion secondary batteries using carbon for a negative electrode active substance, a lithium-transition metal composite oxide for a positive electrode active substance and a carbonic ester mixture for an electrolytic solution have been widely put to practical use because they are able to obtain a high energy density as compared with related-art non-aqueous electrolytic solution secondary batteries such as lead batteries and nickel-cadmium batteries. Also, according to laminated batteries using an aluminum laminated film for an exterior, since the exterior is thin and lightweight, the amount of an active substance can be increased, and the energy density is high.

On the other hand, there is a possibility that when the battery is exposed to a high-temperature atmosphere, the carbonic ester in the electrolytic solution is decomposed upon a reaction with the electrode to generate a gas. In a thin battery such as laminated batteries, such a phenomenon leads to expansion of the battery, and therefore, it is especially problematic. Then, it is proposed to suppress the reduction of a discharge capacity retention rate at the time of charge-discharge cycle by adding fluoroethylene carbonate to an electrolytic solution (see JP-A-2005-38722).

However, in case of using fluoroethylene carbonate, it was still insufficient to suppress the expansion of a battery under a high-temperature atmosphere, and there was room for improvement. Then, it is desirable to provide a battery capable of suppressing the expansion at the time of high-temperature storage while keeping charge-discharge efficiency.

### SUMMARY

According to the present application, it has been found that when an electrolytic solution contains a halide of a specified element, the expansion under a high-temperature atmosphere is reduced while keeping a good charge-discharge cycle characteristic.

According to an embodiment, a non-aqueous electrolytic solution secondary battery and non-aqueous electrolytic solution are provided.

A non-aqueous electrolytic solution secondary battery including a positive electrode, a negative electrode and a non-aqueous electrolytic solution, wherein the non-aqueous electrolytic solution contains a halide of an element selected from the group consisting of Zr and elements belongings to the Group 5, the Group 6 and the Groups 12 to 15 of the Periodic Table.

A non-aqueous electrolytic solution containing a halide of an element selected from the group consisting of Zr and elements belongings to the Group 5, the Group 6 and the Groups 12 to 15 of the Periodic Table.

In accordance with the non-aqueous electrolytic solution and the non-aqueous electrolytic solution secondary battery in an embodiment, it is considered that the generation of a gas to be caused due to a reaction of an electrolytic solution and a battery active substance is suppressed due to the matter that a halide of a specified element to be contained in the electrolytic solution is decomposed on the surface of the electrode at the time of initial charge to form a protective coating of a lithium halide. According to this, not only the expansion of the battery at the time of high-temperature storage can be suppressed, but excellent charge-discharge efficiency can be kept.

Additional features and advantages are described herein, and will be apparent from the following Detailed Description and the figures.

### BRIEF DESCRIPTION OF THE FIGURES

FIG. 1 is an exploded perspective view showing a configuration of a non-aqueous electrolytic solution secondary battery according to an embodiment of the present application.

FIG. 2 is a cross-sectional view showing a configuration along an I-I line of a wound electrode body as shown in FIG. 1.

### DETAILED DESCRIPTION

Best modes for carrying out an embodiment according to the present application are hereunder described in detail with reference to the accompanying drawings, but it should not be construed that the present application is limited thereto.

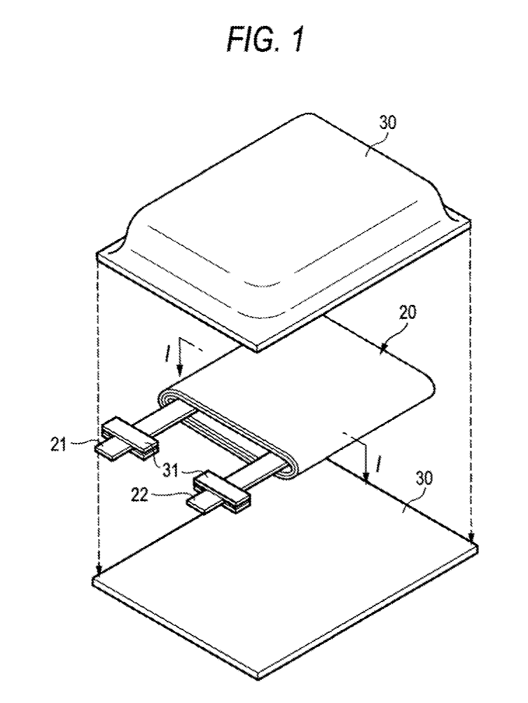

FIG. 1 schematically shows a configuration of a laminate type battery according to an embodiment of the present. This secondary battery is one named as a so-called laminated film type, wherein a wound electrode body 20 having a positive electrode lead 21 and a negative electrode lead 22 installed therein is contained in the side of an exterior member 30 in a film-like state.

The positive electrode lead 21 and the negative electrode lead 22 are each derived in, for example, the same direction from the inside towards the outside of the exterior member 30. The positive electrode lead 21 and the negative electrode lead 22 are each constituted of a metal material such as aluminum, copper, nickel and stainless steel and formed in a thin plate state or a network state.

The exterior member 30 is constituted of a rectangular aluminum laminated film obtained by sticking, for example, a nylon film, an aluminum foil and a polyethylene film in this order. The exterior member 30 is, for example, provided in such a manner that the polyethylene film side and the wound electrode body 20 are disposed opposing to each other, and respective external edges thereof are brought into intimate contact with each other by fusion or an adhesive. An adhesive film 31 is inserted between the exterior member 30 and each of the positive electrode lead 21 and the negative electrode lead 22 for the purpose of preventing invasion of the outside air. The adhesive film 31 is constituted of a material having adhesiveness to the positive electrode lead 21 and the negative electrode lead 22, such as polyolefin resins, for example, polyethylene, polypropylene, modified polyethylene and modified polypropylene.

The exterior member 30 may also be constituted of a laminated film having other structure, a high-molecular film such as polypropylene or a metal film in place of the foregoing aluminum laminated film.

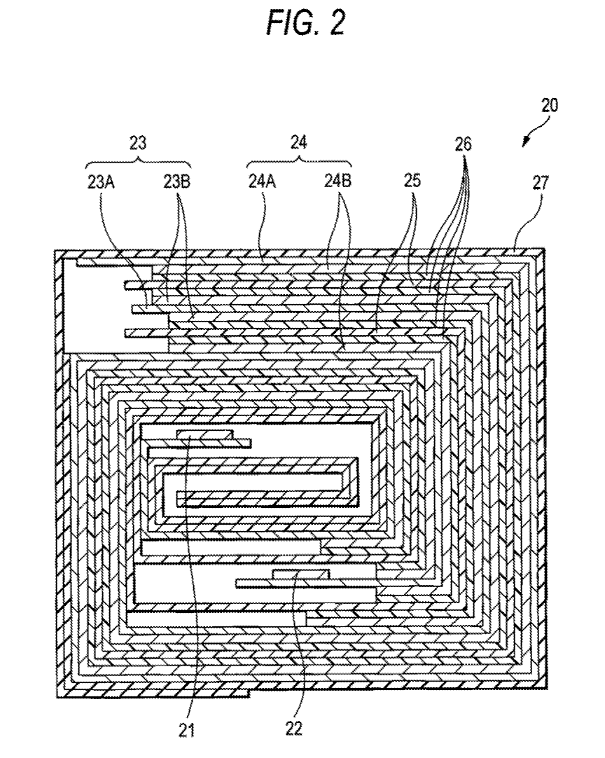

FIG. 2 shows a cross-sectional structure along an I-I line of the wound electrode body 20 as shown in FIG. 1. The wound electrode body 20 is one prepared by laminating and winding a positive electrode 23 and a negative electrode 24 via a separator 25 and an electrolyte layer 26, and an outermost periphery thereof is protected by a protective tape 27.

(Active Substance Layer)

The positive electrode 23 has a structure in which a positive electrode active substance layer 23B is provided on the both surfaces of a positive electrode collector 23A. The negative electrode 24 has a structure in which a negative electrode active substance layer 24B is provided on the both surfaces of a negative electrode collector 24A. The negative electrode substance layer 24B and the positive electrode active substance layer 23B are disposed opposing to each other. In the non-aqueous electrolytic solution secondary battery according an embodiment of the present application, each of the positive electrode active substance layer 23B and the negative electrode active substance layer 24B has a thickness per one surface of 40 μm or more, preferably not more than 80 μm, and more preferably in the range of 40 μm or more and not more than 60 μm. When the thickness of the active substance layer is 40 μm or more, it is possible to devise to realize a high capacity of the battery. Also, where the thickness of the active substance layer is not more than 80 μm, it is possible to make a discharge capacity retention rate at the time of repetition of charge and discharge high.

(Positive Electrode)

The positive electrode collector 23A is constituted of a metal material, for example, aluminum, nickel and stainless steel. The positive electrode active substance layer 23B contains, as a positive electrode active substance, any one kind or plural kinds of a positive electrode material capable of occluding and releasing lithium and may contain a conductive agent such as carbon materials and a binder such as polyvinylidene fluoride as the need arises.

As the positive electrode material capable of occluding and releasing lithium, lithium composite oxides, for example, lithium cobaltate, lithium nickelate and solid solutions thereof (Li(NixCoyMnz)O2) (wherein values of x, y and z are satisfied with the relationships of 0<x<1, 0<y<1, 0≦z<1 and (x+y+z)=1), and manganese spinel (LiMn2O4) and solid solutions thereof (Li(Mn2-vNiv)O4) (wherein a value of v is satisfied with the relationship of v<2); and phosphoric acid compounds having an olivine structure, for example, lithium iron phosphate (LiFePO4) are preferable. This is because a high energy density is obtainable. Also, examples of the positive electrode material capable of occluding and releasing lithium include oxides, for example, titanium oxide, vanadium oxide and manganese dioxide; disulfides, for example, iron disulfide, titanium disulfide and molybdenum disulfide; sulfur; and conductive polymers, for example, polyaniline and polythiophene.

(Negative Electrode)

The negative electrode 24 has, for example, a structure in which the negative electrode substance layer 24B is provided on the both surfaces of the negative electrode collector 24A having a pair of opposing surfaces. The negative electrode collector 24A is constituted of a metal material, for example, a copper, nickel and stainless steel.

The negative electrode active substance layer 24B contains, as a negative electrode substance, any one kind or plural kinds of a negative electrode material capable of occluding and releasing lithium. This secondary battery is designed such that the charge capacity of the negative electrode material capable of occluding and releasing lithium is larger than the charge capacity of the positive electrode 23 and that a lithium metal is not deposited on the negative electrode 24 on the way of charge.

Examples of the negative electrode material capable of occluding and releasing lithium include carbon materials, for example, hardly graphitized carbon, easily graphitized carbon, graphite, pyrolytic carbons, cokes, vitreous carbons, organic high-molecular compound burned materials, carbon fibers and active carbon. Of these, examples of the cokes include pitch coke, needle coke and petroleum coke. The organic high-molecular compound burned material as referred to herein is a material obtained through carbonization by burning a high-molecular material such as phenol resins and furan resins at an appropriate temperature, and a part thereof is classified into hardly graphitized carbon or easily graphitized carbon. Also, examples of the high-molecular material include polyacetylene and polypyrrole. Such a carbon material is preferable because a change in the crystal structure to be generated at the time of charge and discharge is very small, a high charge-discharge capacity can be obtained, and a good cycle characteristic can be obtained. In particular, graphite is preferable because its electrochemical equivalent is large, and a high energy density can be obtained. Also, hardly graphitized carbon is preferable because excellent characteristics are obtainable. Moreover, a material having a low charge-discharge potential, specifically one having a charge-discharge potential close to a lithium metal, is preferable because it is easy to realize a high energy density of the battery.

Also, besides the above-exemplified carbon materials, materials containing silicon, tin or a compound thereof, or an element capable of forming an alloy together with lithium, for example, magnesium, aluminum and germanium may be used as the negative electrode material. Furthermore, a material containing an element capable of forming a composite oxide together with lithium, for example, titanium is considerable.

(Separator)

The separator 25 is one which partitions the positive electrode 23 and the negative electrode 24 from each other and passes a lithium ion therethrough while preventing a short circuit of the current due to contact of the both electrodes. This separator 25 is constituted of a porous membrane made of a synthetic resin, for example, polytetrafluoroethylene, polypropylene and polyethylene, or a porous membrane made of a ceramic and may also have a structure in which plural kinds of such a porous membrane are laminated. The separator 25 is impregnated with, for example, an electrolytic solution which is a liquid electrolyte.

(Non-Aqueous Electrolytic Solution)

The non-aqueous electrolytic solution (hereinafter also referred to simply as “electrolytic solution”) in an embodiment according to the present application contains a halide of an element selected from the group consisting of Zr and elements belongings to the Group 5, the Group 6 and the Groups 12 to 15 of the Periodic Table (hereinafter also referred to simply as “halide”). It is considered that such a halide is decomposed on the surface of the electrode at the time of initial charge to form a protective coating of a lithium halide, thereby suppressing the generation of a gas to be caused due to a reaction of the electrolytic solution and the battery active substance. Also, it is considered that a halide ion is not formed during the course of dissolution of such a halide in the electrolytic solution. When a halide ion is present, it is bound to the lithium ion in the electrolytic solution and converted into an insoluble lithium halide, thereby causing cloudiness. However, even when the foregoing halide to be used in an embodiment according to the present application is dissolved in the electrolytic solution, such a phenomenon is not observed.

Examples of the foregoing element selected from the group consisting of Zr and elements belongings to the Group 5, the Group 6 and the Groups 12 to 15 of the Periodic Table include zirconium; vanadium, niobium and tantalum belonging to the Group 5; molybdenum and tungsten belonging to the Group 6; zinc belonging to the Group 12; aluminum, gallium and indium belonging to the Group 13; silicon, germanium and tin belonging to the Group 14; and phosphorus and antimony belonging to the Group 15. Of these, from the viewpoint of easily forming an oxide coating, elements selected from those belonging to the Group 6 or the Group 13 are preferable, and molybdenum is the most preferable.

Also, among the halides, a chloride is considered to be effective. This is because a fluoride is large in iconicity as compared with the chloride so that its solubility in an organic electrolytic solution is low; and a bromide hardly forms a protective coating because of high solubility of lithium bromide to be formed.

A concentration of the halide in the non-aqueous electrolytic solution is preferably from 0.02 to 0.50% by weight, and more preferably from 0.05 to 0.2% by weight. What the concentration of the halide in the non-aqueous electrolytic solution falls within the range of from 0.02 to 0.50% by weight is preferable because not only a sufficient coating is formed, but its resistance is low.

It is effective to combine such a halide with a carbonic ester. It is considered that such a carbonic ester forms a protective coating by another mechanism, thereby suppressing the generation of a gas. As the carbonic ester, cyclic carbonic esters such as vinylene carbonate, ethylene carbonate, propylene carbonate, butylene carbonate and vinyl ethylene carbonate; halogenated carbonic esters obtained by substituting a part of such a cyclic carbonic ester with a halogen; and the like are preferable. The content of the carbonic ester is preferably from 0.1 to 2% by weight. When the content of the carbonic ester falls within the foregoing range, a sufficient coating is formed, and its resistance is low.

The non-aqueous electrolytic solution in an embodiment according to the present application further contains a solvent and an electrolyte salt as dissolved in the solvent. The solvent to be used in the electrolytic solution is preferably a high-dielectric solvent having a dielectric constant of 30 or more. This is because according to this, the number of the lithium ion can be increased. The content of the high-dielectric solvent in the electrolytic solution is preferably in the range of from 15 to 50% by weight. This is because when the content of the high-dielectric solvent in the electrolytic solution falls within the foregoing range, higher charge-discharge efficiency is obtainable.

Examples of the high-dielectric solvent include cyclic carbonic esters such as vinylene carbonate, ethylene carbonate, propylene carbonate, butylene carbonate and vinyl ethylene carbonate; lactones such as γ-butyrolactone and γ-valerolactone; lactams such as N-methyl-2-pyrrolidone; cyclic carbamic esters such as N-methyl-2-oxazolidinone; and sulfone compounds such as tetramethylene sulfone. In particular, cyclic carbonic esters are preferable; and ethylene carbonate and vinylene carbonate having a carbon-carbon double bond are more preferable. Also, the high-dielectric solvent may be used singly or in admixture of two or more kinds thereof.

As the solvent to be used in the electrolytic solution, it is preferable to use a mixture of the foregoing high-dielectric solvent with a low-viscosity solvent having a viscosity of not more than 1 mP·s. This is because according to this, high ionic conductivity can be obtained. A ratio (mass ratio) of the low-viscosity solvent relative to the high-dielectric solvent is preferably in the range of from 2/8 to 5/5 in terms of a ratio of the high-dielectric solvent to the low-viscosity solvent. This is because when the ratio of the high-dielectric solvent to the low-viscosity solvent falls within this range, a higher effect is obtainable.

Examples of the low-viscosity solvent include chain carbonic esters such as dimethyl carbonate, diethyl carbonate, ethylmethyl carbonate and methylpropyl carbonate; chain carboxylic acid esters such as methyl acetate, ethyl acetate, methyl propionate, ethyl propionate, methyl butyrate, methyl isobutyrate, methyl trimethylacetate and ethyl trimethylacetate; chain amides such as N,N-dimethylacetamide; chain carbamic esters such as methyl N,N-diethylcarbamate and ethyl N,N-diethylcarbamate; and ethers such as 1,2-dimethoxyethane, tetrahydrofuran, tetrahydropyran and 1,3-dioxolan. Such a low-viscosity solvent may be used singly or in admixture of two or more kinds thereof.

Examples of the electrolyte salt include inorganic lithium salts such as lithium hexafluorophosphate (LiPF6), lithium tetrafluoroborate (LiBF4), lithium hexafluoroarsenate (LiAsF6), lithium hexafluoroantimonate (LiSbF6), lithium perchlorate (LiClO4) and lithium tetrachloroaluminate (LiAlCl4); and lithium salts of a perfluoroalkanesulfonic acid derivative such as lithium trifluoromethanesulfonate (CF3SO3Li), lithium bis(trifluoromethanesulfone)imide [(CF3SO2)2NLi], lithium bis(pentafluoroethanesulfone)imide [(C2F5SO2)2NLi] and lithium tris(trifluoromethanesulfone)methide [(CF3SO2)3CLi]. The electrolyte salt may be used singly or in admixture of two or more kinds thereof. The content of the electrolyte salt in the electrolytic solution is preferably from 6 to 25% by weight.

(High-Molecular Compound)

The battery in an embodiment may be formed in a gel state by containing a high-molecular compound which is swollen by the electrolytic solution to become a supporter for supporting the electrolytic solution. This is because by containing the high-molecular compound which is swollen by the electrolytic solution, high ionic conductivity can be obtained, excellent charge-discharge efficiency is obtainable, and liquid leakage of the battery can be presented. In the case where a high-molecular compound is added to the electrolytic solution and used, the content of the high-molecular compound in the electrolytic solution is preferably in the range of 0.1% by weight or more and not more than 2.0% by weight. Also, in the case where a high-molecular compound such as polyvinylidene fluoride is coated on the both surfaces of the separator and used, a mass ratio of the electrolytic solution to the high-molecular compound is preferably in the range of from 50/1 to 10/1. This is because when the mass ratio of the electrolytic solution to the high-molecular compound falls within this range, higher charge-discharge efficiency is obtainable.

Examples of the high-molecular compound include ether based high-molecular compounds such as polyvinyl formal, polyethylene oxide and polyethylene oxide-containing crosslinked materials as represented by the following formula (1); ester based high-molecular compounds such as polymethacrylates as represented by the following formula (2); and polymers of vinylidene fluoride such as polyvinylidene fluoride and a copolymer of vinylidene fluoride and hexafluoropropylene as represented by the following formula (3). The high-molecular compound may be used singly or in admixture of plural kinds thereof. In particular, from the viewpoint of an effect for preventing swelling at the time of high-temperature storage, it is desirable to use a fluorocarbon based high-molecular compound such as polyvinylidene fluoride.

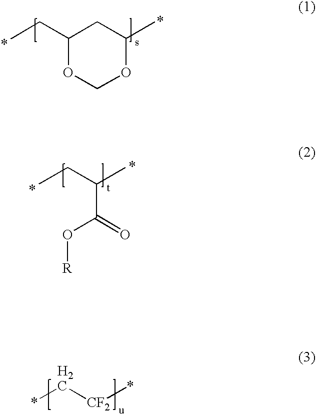

In the foregoing formulae (1) to (3), s, t and u each represents an integer of from 100 to 10,000; and R represents CxH2x-1Oy (wherein x is from 1 to 8; and y is from 0 to 4).

(Manufacturing Method)

This secondary battery can be, for example, manufactured in the following manner.

A positive electrode can be, for example, prepared in the following method. First of all, a positive electrode substance, a conductive agent and a binder are mixed to prepare a positive electrode mixture; and this positive electrode mixture is dispersed in a solvent such as N-methyl-2-pyrrolidone to form a positive electrode mixture slurry in a paste state. Subsequently, this positive electrode mixture slurry is coated on the positive electrode collector 23A; and after drying the solvent, compression molding is carried out by using a roll press, etc. to form the positive electrode active substance layer 23B. There is thus prepared the positive electrode 23. On that occasion, the positive electrode active substance layer 23B is regulated so as to have a thickness of 40 μm or more.

Also, a negative electrode can be, for example, prepared in the following method. First of all, a negative electrode active substance containing at least one of silicon and tin as a constitutional element, a conductive agent and a binder are mixed to prepare a negative electrode mixture; and this negative electrode mixture is then dispersed in a solvent such as N-methyl-2-pyrrolidone to form a negative electrode mixture slurry in a paste state. Subsequently, this negative electrode mixture slurry is coated on the negative electrode collector 24A, dried and then subjected to compression molding to form the negative electrode active substance layer 24B containing a negative electrode active substance particle composed of the foregoing negative electrode active substance. There is thus obtained the negative electrode 24. On that occasion, the negative electrode active substance layer 24B is regulated so as to have a thickness of 40 μm or more.

Next, a precursor solution containing an electrolytic solution, a high-molecular compound and a mixed solvent is coated on each of the positive electrode 23 and the negative electrode 24, and the mixed solvent is volatized to form the electrolyte layer 26. Next, the positive electrode lead 21 is installed in the positive electrode collector 23A, and the negative electrode lead 22 is also installed in the negative electrode collector 24A. Subsequently, the positive electrode 23 and the negative electrode 24, on each of which is formed the electrolyte layer 26, are laminated via the separator 25 to form a laminate; this laminate is wound in its longitudinal direction; and the protective tape 27 is bonded to the outermost periphery to form the wound electrode body 20. Thereafter, for example, the wound electrode body 20 is put into the exterior members 30; the external edges of the exterior members 30 are adhered closely and sealed by means of heat fusion. On that occasion, the adhesive film 31 is inserted between each of the positive electrode lead 21 and the negative electrode lead 22 and the exterior body 30. There is thus completed the secondary battery as shown in FIGS. 1 and 2.

Also, this secondary battery may be prepared in the following manner. First of all, as described above, the positive electrode 23 and the negative electrode 24 are prepared; the positive electrode lead 21 and the negative electrode lead 22 are installed in the positive electrode 23 and the negative electrode 24, respectively; the positive electrode 23 and the negative electrode 24 are laminated via the separator 25 and wound; and the protective tape 27 is bonded to the outermost periphery to form a wound body which is a precursor of the wound electrode body 20. Subsequently, this wound body is put between the exterior members 30; and the external edges excluding one side are heat fused to form a bag-like material, whereby the wound body is contained in the inside of the exterior member 30. Subsequently, an electrolyte composition containing an electrolytic solution and a monomer as a raw material of the high-molecular compound and optionally containing a polymerization initiator or a polymerization inhibitor or the like is prepared and poured into the inside of the exterior member 30; and an opening of the exterior member 30 is then sealed by means of heat fusion. Thereafter, if desired, the monomer is polymerized to form a high-molecular compound by heating to form the electrolyte layer 26 in a gel state. There is thus assembled the secondary battery as shown in FIGS. 1 and 2.

In this secondary battery, when charge is carried out, for example, a lithium ion is released from the positive electrode 23 and occluded in the negative electrode 24 via the electrolytic solution. On the other hand, when discharge is carried out, for example, a lithium ion is released from the negative electrode 24 and occluded in the positive electrode 24 via the electrolytic solution.

Embodiments have been described. However, it should not be construed that the present application is not limited thereto, and various changes and modifications can be made therein. For example, in the foregoing embodiments, the case of using an electrolytic solution as the electrolyte has been described, and the case of using the gel-like electrolyte having an electrolytic solution supported on a high-molecular compound has also be described. However, other electrolytes may be used. Examples of other electrolytes include mixtures of an ionically conductive inorganic compound (for example, ionically conductive ceramics, ionically conductive glasses and ionic crystals) and an electrolytic solution; mixtures of other inorganic compound and an electrolytic solution; and mixtures of such an inorganic compound and a gel-like electrolyte.

Also, in the foregoing embodiments, the battery using lithium as an electrode reactant has been described. However, the present application is applicable to the case of using other alkali metal (for example, sodium (Na) and potassium (K)), an alkaline earth metal (for example, magnesium and calcium (Ca)) or other light metal (for example, aluminum).

Furthermore, in the foregoing embodiments, the so-called lithium ion secondary battery in which the capacity of the negative electrode is expressed by the capacity component due to the occlusion and release of lithium; and the so-called lithium metal secondary battery in which a lithium metal is used as the negative electrode substance, and the capacity of the negative electrode is expressed by the capacity component due to the deposition and dissolution of lithium have been described. However, the present application is similarly applicable to a secondary battery in which by controlling the charge capacity of a negative electrode material capable of occluding and releasing lithium smaller than the charge capacity of a positive electrode, the capacity of the negative electrode includes a capacity component due to the occlusion and release of lithium and a capacity component due to the deposition and dissolution of lithium and is expressed by the sum thereof.

Moreover, in the foregoing embodiments, the laminate type secondary battery has been specifically referred to and described. However, needless to say, the present application is not limited to the foregoing shape. That is, the present application is applicable to cylindrical batteries, square-shaped batteries and the like. Also, the present application is applicable to not only the secondary batteries but other batteries such as primary batteries.

### EXAMPLES

### Examples 1-1 to 1-13

### Example 1-1

First of all, 94 parts by weight of a lithium/cobalt composite oxide (LiCoO2) as a positive electrode active substance, 3 parts by weight of graphite as a conductive material and 3 parts by weight of polyvinylidene fluoride (PVdF) as a binder were uniformly mixed, to which was then added N-methylpyrrolidone to obtain a positive electrode mixture coating solution. Next, the obtained positive electrode mixture coating solution was uniformly coated on the both surfaces of an aluminum foil having a thickness of 20 μm and dried to form a positive electrode mixture layer of 40 mg/cm2 per one surface. This was cut into a shape of 50 mm in width and 300 mm in length to prepare a positive electrode.

Next, 97 parts by weight of graphite as a negative electrode active substance and 3 parts by weight of PVdF as a binder were uniformly mixed, to which was then added N-methylpyrrolidone to obtain a negative electrode mixture coating solution. Next, the obtained negative electrode mixture coating solution was uniformly coated on the both surfaces of a copper foil having a thickness of 20 μm as a negative electrode collector and dried to form a negative electrode mixture layer of 20 mg/cm2 per one surface. This was cut into a shape of 50 mm in width and 300 mm in length to prepare a negative electrode.

An electrolytic solution was prepared by mixing ethylene carbonate (EC), ethylmethyl carbonate (EMC), lithium hexafluorophosphate and molybdenum(V) chloride in a proportion of 34/51/14.9/0.1 (mass ratio). The molybdenum(V) chloride was procured from Sigma Aldrich Japan K.K. (the same as in halides as described later).

The positive electrode and the negative electrode were laminated via a separator made of a microporous polyethylene film having a thickness of 9 μm and wound up, and then charged in a bag made of an aluminum laminated film. 2 g of the electrolytic solution was poured into this bag, and the bag was heat fused to prepare a laminate type battery. This battery had a capacity of 700 mAh.

This battery was charged for 3 hours under an atmosphere at 23° C. with an upper limit being 4.2 V at 700 mAh and then stored at 90° C. for 4 hours. At that time, a change in the thickness of the battery is expressed as an expansion rate (%) and shown in Table 1. The expansion ratio is a value obtained by calculation while the battery thickness before the storage is a dominator, whereas the increased thickness at the time of storage is a numerator. Also, a discharge capacity retention rate at the time of repeating discharge with a lower limit being 3.0 V at 700 mAh 300 times after charge for 3 hours under an atmosphere at 23° C. with an upper limit being 4.2 V at 700 mAh is shown in Table 1.

### Examples 1-2 and 1-3

Laminate type batteries were prepared in the same manner as in Example 1-1, except for changing the concentration of molybdenum(V) chloride to 0.02% by weight and 0.50% by weight, respectively and increasing or decreasing the amount of lithium hexafluorophosphate in conformity therewith. A change in the thickness of the battery in terms of an expansion rate (%) and a discharge capacity retention rate at the time of repeating discharge 300 times are shown in Table 1.

### Examples 1-4 to 1-13

Laminate type batteries were prepared in the same manner as in Example 1-1, except for blending each of halides as shown in Table 1 in places of the molybdenum(V) chloride. A change in the thickness of the battery in terms of an expansion rate (%) and a discharge capacity retention rate at the time of repeating discharge 300 times are shown in Table 1.

### Comparative Example 1-1

A laminate type battery was prepared in the same manner as in Example 1-1, except for not blending the molybdenum(V) chloride and increasing the amount of lithium hexafluorophosphate in conformity therewith. A change in the thickness of the battery in terms of an expansion rate (%) and a discharge capacity retention rate at the time of repeating discharge 300 times are shown in Table 1.

TABLE 1
Battery having electrolytic solution not supported on high-molecular compound

| | | | Expansion rate | |
|---|---|---|---|---|
| | Halide | | of battery after | |
| | | % by weight | storing at 90° C. | Retention rate |
| | | (based on the | for 4 hours | after 300 cycles |
| | Kind | solvent) | (%) | (%) |
| Example 1-1 | Molybdenum(V) chloride | 0.10 | 13 | 86.3 |
| Example 1-2 | Molybdenum(V) chloride | 0.02 | 22 | 86.9 |
| Example 1-3 | Molybdenum(V) chloride | 0.50 | 11 | 86.2 |
| Example 1-4 | Zirconium(IV) chloride | 0.10 | 14 | 87.3 |
| Example 1-5 | Niobium(V) chloride | 0.10 | 14 | 86.3 |
| Example 1-6 | Tantalum(V) chloride | 0.10 | 14 | 86.2 |
| Example 1-7 | Tungsten(VI) chloride | 0.10 | 14 | 87.1 |
| Example 1-8 | Zinc(II) chloride | 0.10 | 11 | 86.3 |
| Example 1-9 | Aluminum(III) chloride | 0.10 | 12 | 86.5 |
| Example 1-10 | Gallium(III) chloride | 0.10 | 10 | 86.4 |
| Example 1-11 | Silicon(IV) chloride | 0.10 | 17 | 86.6 |
| Example 1-12 | Germanium(IV) chloride | 0.10 | 17 | 86.5 |
| Example 1-13 | Phosphorus(V) chloride | 0.10 | 12 | 86.2 |
| Comparative | Nil | 0 | 33 | 84.8 |
| Example 1-1 | | | | |

As shown in Table 1, in Example 1-1 containing molybdenum chloride in the electrolytic solution, the expansion rate of the battery was reduced by 20%, and the discharge capacity retention rate after 300 cycles was enhanced as compared with Comparative Example 1-1 not containing molybdenum chloride in the electrolytic solution. That is, it was noted that by blending a halide, an aspect of which is characteristic of an embodiment, the expansion of the battery at the time of high-temperature storage is suppressed, and the cycle characteristic is enhanced.

Also, in Example 1-2 in which the blending amount of molybdenum chloride is smaller than that in Example 1-1, though the results reveal that the expansion rate is higher than that in Example 1-1, the expansion rate could be reduced by 10% as compared with Comparative Example 1-1 not blending molybdenum chloride. On the other hand, in Example 1-3 in which the blending amount of molybdenum chloride is larger than that in Example 1-1, the expansion rate could be more reduced. Also, with respect to the discharge capacity retention rate after 300 cycles, both Examples 1-2 and 1-3 were enhanced to the same degree as in Example 1-1. That is, it was noted that the optimal content of the halide is from 0.02 to 0.50% by weight.

In all of Examples 1-4 to 1-13 in which the halide was changed, the expansion rate of the battery could be reduced by the order of 10%, and the discharge capacity retention rate after 300 cycles was enhanced. In particular, in Example 1-10 in which gallium(III) chloride was blended, nevertheless the blending amount of the halide was one fifth of that in Example 1-3 in which molybdenum(V) chloride was blended in an amount of 0.5% by weight, the effect for reducing the expansion of the same degree as in Example 1-3 was obtained. That is, it was noted that even by blending a chloride of an element selected from group consisting of Zr and elements belongings to the Group 5, the Group 6 and the Groups 12 to 15 of the Periodic Table other than molybdenum chloride in the electrolytic solution, the expansion of the battery at the time of high-temperature storage is suppressed, and the cycle characteristic is enhanced.

### Examples 2-1 to 2-18

### Example 2-1

A laminate type battery was prepared in the same manner as in Example 1-1, except for blending 1% by weight of fluoroethylene carbonate (FEC) in the electrolytic solution and decreasing the amount of ethylene carbon (EC) in conformity therewith. A change in the thickness of the battery in terms of an expansion rate (%) and a discharge capacity retention rate at the time of repeating discharge 300 times are shown in Table 2.

### Examples 2-2 and 2-3

Laminate type batteries were prepared in the same manner as in Example 2-1, except for changing the concentration of molybdenum(V) chloride to 0.02% by weight and 0.50% by weight, respectively and increasing or decreasing the amount of lithium hexafluorophosphate in conformity therewith. A change in the thickness of the battery in terms of an expansion rate (%) and a discharge capacity retention rate at the time of repeating discharge 300 times are shown in Table 2.

### Example 2-4

A laminate type battery was prepared in the same manner as in Example 1-1, except for blending 1% by weight of vinylene carbonate (VC) in the electrolytic solution and decreasing the amount of ethylene carbon (EC) in conformity therewith. A change in the thickness of the battery in terms of an expansion rate (%) and a discharge capacity retention rate at the time of repeating discharge 300 times are shown in Table 2.

### Examples 2-5 to 2-18

Laminate type batteries were prepared in the same manner as in Example 2-1, except for blending each of halides as shown in Table 2 in places of the molybdenum(V) chloride. A change in the thickness of the battery in terms of an expansion rate (%) and a discharge capacity retention rate at the time of repeating discharge 300 times are shown in Table 2.

### Comparative Example 2-1

A laminate type battery was prepared in the same manner as in Example 2-1, except for not blending the molybdenum(V) chloride and increasing the amount of lithium hexafluorophosphate in conformity therewith. A change in the thickness of the battery in terms of an expansion rate (%) and a discharge capacity retention rate at the time of repeating discharge 300 times are shown in Table 2.

TABLE 2
Battery having electrolytic solution not supported on high-molecular compound

| | | | | | Expansion rate of | |
|---|---|---|---|---|---|---|
| | Halide | | FEC | VC | battery after | |
| | | % by weight | % by weight | % by weight | storing at 90° C. | Retention rate |
| | | (based on the | (based on the | (based on the | for 4 hours | after 300 cycles |
| | Kind | solvent) | solvent) | solvent) | (%) | (%) |
| Example 2-1 | Molybdenum(V) chloride | 0.10 | 1.0 | 0 | 12 | 87.5 |
| Example 2-2 | Molybdenum(V) chloride | 0.02 | 1.0 | 0 | 24 | 85.6 |
| Example 2-3 | Molybdenum(V) chloride | 0.50 | 1.0 | 0 | 12 | 84.9 |
| Example 2-4 | Molybdenum(V) chloride | 0.10 | 0 | 1.0 | 13 | 88.7 |
| Example 2-5 | Zirconium(IV) chloride | 0.10 | 1.0 | 0 | 16 | 86.0 |
| Example 2-6 | Vanadium(III) chloride | 0.10 | 1.0 | 0 | 32 | 84.9 |
| Example 2-7 | Niobium(V) chloride | 0.10 | 1.0 | 0 | 16 | 85.0 |
| Example 2-8 | Tantalum(V) chloride | 0.10 | 1.0 | 0 | 16 | 84.9 |
| Example 2-9 | Tungsten(VI) chloride | 0.10 | 1.0 | 0 | 16 | 85.8 |
| Example 2-10 | Zinc(II) chloride | 0.10 | 1.0 | 0 | 13 | 85.0 |
| Example 2-11 | Aluminum(III) chloride | 0.10 | 1.0 | 0 | 13 | 85.2 |
| Example 2-12 | Gallium(III) chloride | 0.10 | 1.0 | 0 | 11 | 85.1 |
| Example 2-13 | Indium(III) chloride | 0.10 | 1.0 | 0 | 28 | 84.8 |
| Example 2-14 | Silicon(IV) chloride | 0.10 | 1.0 | 0 | 19 | 85.3 |
| Example 2-15 | Germanium(IV) chloride | 0.10 | 1.0 | 0 | 19 | 85.2 |
| Example 2-16 | Tin(VI) chloride | 0.10 | 1.0 | 0 | 28 | 84.8 |
| Example 2-17 | Phosphorus(V) chloride | 0.10 | 1.0 | 0 | 13 | 84.9 |
| Example 2-18 | Antimony(V) chloride | 0.10 | 1.0 | 0 | 25 | 84.8 |
| Comparative | Nil | 0 | 1.0 | 0 | 34 | 83.5 |
| Example 2-1 | | | | | | |

As shown in Table 2, in Example 2-1 containing molybdenum chloride and FEC in the electrolytic solution, the expansion rate of the battery was reduced by 20%, and the discharge capacity retention rate after 300 cycles was enhanced as compared with Comparative Example 2-1 containing FEC but not containing molybdenum chloride in the electrolytic solution. That is, it was noted that the joint use of FEC and a halide are excellent in the effect for suppressing the expansion of the battery and the discharge capacity retention rate as compared with the single use of FEC.

Also, the results reveal that Example 1-1 containing only molybdenum chloride is excellent in both the effect for suppressing the expansion rate of the battery and the discharge capacity retention rate as compared with Comparative Example 2-1 containing only FEC. That is, it was noted that the halide is excellent in the effect for suppressing the expansion of the battery and the discharge capacity retention rate as compared with FEC.

Also, in Example 2-2 in which the blending amount of molybdenum chloride is smaller than that in Example 2-1, though the results reveal that the expansion rate is higher than that in Example 2-1, the expansion rate could be reduced by 10% as compared with Comparative Example 2-1 not blending molybdenum chloride. On the other hand, in Example 2-3 in which the blending amount of molybdenum chloride is larger than that in Example 2-1, the expansion rate was in the same degree. That is, it was noted that when used jointly with FEC, the optimal content of the halide is from 0.02 to 0.50% by weight.

In Example 2-4 using VC in place of FEC, though the expansion rate was slightly lower than that in Example 2-1, the discharge capacity retention rate after 300 cycles was enhanced as compared with Example 2-1.

In all of Examples 2-5 to 2-18 in which the halide was changed, the expansion rate of the battery could be reduced, and the discharge capacity retention rate after 300 cycles was enhanced as compared with Comparative Example 2-1 not containing a halide. That is, it was noted that even by blending a chloride of an element selected from group consisting of Zr and elements belongings to the Group 5, the Group 6 and the Groups 12 to 15 of the Periodic Table other than molybdenum chloride in the electrolytic solution, the expansion of the battery at the time of high-temperature storage is suppressed, and the cycle characteristic is enhanced.

### Examples 3-1 to 3-13

### Example 3-1

A laminate type battery was prepared in the same manner as in Example 1-1, except for using a separator prepared by changing the thickness to 7 μm and coating polyvinylidene fluoride in a thickness of 2 μm on the both surfaces thereof. At that time, a weight ratio of the electrolytic solution to polyvinylidene fluoride was 20/1. A change in the thickness of the battery in terms of an expansion rate (%) and a discharge capacity retention rate at the time of repeating discharge 300 times are shown in Table 3.

### Examples 3-2 and 3-3

Laminate type batteries were prepared in the same manner as in Example 3-1, except for changing the concentration of molybdenum(V) chloride to 0.05% by weight and 0.50% by weight, respectively and increasing or decreasing the amount of lithium hexafluorophosphate in conformity therewith. A change in the thickness of the battery in terms of an expansion rate (%) and a discharge capacity retention rate at the time of repeating discharge 300 times are shown in Table 3.

### Examples 3-4 to 3-13

Laminate type batteries were prepared in the same manner as in Example 3-1, except for blending each of halides as shown in Table 3 in places of the molybdenum(V) chloride. A change in the thickness of the battery in terms of an expansion rate (%) and a discharge capacity retention rate at the time of repeating discharge 300 times are shown in Table 3.

### Comparative Example 3-1

A laminate type battery was prepared in the same manner as in Example 3-1, except for not blending the molybdenum(V) chloride and increasing the amount of lithium hexafluorophosphate in conformity therewith. A change in the thickness of the battery in terms of an expansion rate (%) and a discharge capacity retention rate at the time of repeating discharge 300 times are shown in Table 3.

TABLE 3
High-molecular compound: Polyvinylidene fluoride

| | | | Expansion rate | |
|---|---|---|---|---|
| | Halide | | of battery after | Retention rate |
| | | % by weight | storing at 90° C. | after 300 |
| | | (based on the | for 4 hours | cycles |
| | Kind | solvent) | (%) | (%) |
| Example 3-1 | Molybdenum(V) | 0.10 | 9 | 85.0 |
| | chloride | | | |
| Example 3-2 | Molybdenum(V) | 0.05 | 15 | 85.6 |
| | chloride | | | |
| Example 3-3 | Molybdenum(V) | 0.50 | 7 | 84.9 |
| | chloride | | | |
| Example 3-4 | Zirconium(IV) chloride | 0.10 | 10 | 86.0 |
| Example 3-5 | Niobium(V) chloride | 0.10 | 9 | 85.0 |
| Example 3-6 | Tantalum(V) chloride | 0.10 | 9 | 84.9 |
| Example 3-7 | Tungsten(VI) chloride | 0.10 | 9 | 85.8 |
| Example 3-8 | Zinc(II) chloride | 0.10 | 8 | 85.0 |
| Example 3-9 | Aluminum(III) chloride | 0.10 | 8 | 85.2 |
| Example 3-10 | Gallium(III) chloride | 0.10 | 7 | 85.1 |
| Example 3-11 | Silicon(IV) chloride | 0.10 | 11 | 85.3 |
| Example 3-12 | Germanium(IV) chloride | 0.10 | 12 | 85.2 |
| Example 3-13 | Phosphorus(V) chloride | 0.10 | 8 | 84.9 |
| Comparative | Nil | 0 | 22 | 83.6 |
| Example 3-1 | | | | |

As shown in Table 3, in Example 3-1 containing molybdenum chloride in the electrolytic solution, the expansion rate of the battery was reduced, and the discharge capacity retention rate after 300 cycles was enhanced as compared with Comparative Example 3-1 not containing molybdenum chloride in the electrolytic solution. Also, the effect for suppressing the expansion was more enhanced as compared with Example 1-1 not containing polyvinylidene fluoride. According to this, it was noted that the effect for suppressing the expansion can be more enhanced by using polyvinylidene fluoride as the high-molecular compound in addition to containing molybdenum chloride in the electrolytic solution.

Also, in Example 3-2 in which the blending amount of molybdenum chloride is smaller than that in Example 3-1, though the results reveal that the expansion rate is higher than that in Example 3-1, the expansion rate could be reduced as compared with Comparative Example 3-1 not blending molybdenum chloride. On the other hand, in Example 3-3 in which the blending amount of molybdenum chloride is larger than that in Example 3-1, the expansion rate could be more reduced. Also, with respect to the discharge capacity retention rate after 300 cycles, both Examples 3-2 and 3-3 were enhanced to the same degree as in Example 3-1.

In all of Examples 3-4 to 3-13 in which the halide was changed, the expansion rate of the battery could be reduced, and the discharge capacity retention rate after 300 cycles was enhanced as compared with Comparative Example 3-1 not blending the halide. In particular, in Example 3-10 in which gallium(III) chloride was blended, nevertheless the blending amount of the halide was one fifth of that in Example 3-3 in which molybdenum(V) chloride was blended in an amount of 0.5% by weight, the effect for reducing the expansion of the same degree as in Example 3-3 was obtained.

### Examples 4-1 to 4-18

### Example 4-1

A laminate type battery was prepared in the same manner as in Example 3-1, except for blending 1% by weight of fluoroethylene carbonate (FEC) in the electrolytic solution and decreasing the amount of ethylene carbon (EC) in conformity therewith. A change in the thickness of the battery in terms of an expansion rate (%) and a discharge capacity retention rate at the time of repeating discharge 300 times are shown in Table 4.

### Examples 4-2 and 4-3

Laminate type batteries were prepared in the same manner as in Example 4-1, except for changing the concentration of molybdenum(V) chloride to 0.05% by weight and 0.50% by weight, respectively and increasing or decreasing the amount of lithium hexafluorophosphate in conformity therewith. A change in the thickness of the battery in terms of an expansion rate (%) and a discharge capacity retention rate at the time of repeating discharge 300 times are shown in Table 4.

### Example 4-4

A laminate type battery was prepared in the same manner as in Example 3-1, except for blending 1% by weight of vinylene carbonate (VC) in the electrolytic solution and decreasing the amount of ethylene carbon (EC) in conformity therewith. A change in the thickness of the battery in terms of an expansion rate (%) and a discharge capacity retention rate at the time of repeating discharge 300 times are shown in Table 4.

### Examples 4-5 to 4-18

Laminate type batteries were prepared in the same manner as in Example 4-1, except for blending each of halides as shown in Table 4 in places of the molybdenum(V) chloride. A change in the thickness of the battery in terms of an expansion rate (%) and a discharge capacity retention rate at the time of repeating discharge 300 times are shown in Table 2.

### Comparative Example 4-1

A laminate type battery was prepared in the same manner as in Example 4-1, except for not blending the molybdenum(V) chloride and increasing the amount of lithium hexafluorophosphate in conformity therewith. A change in the thickness of the battery in terms of an expansion rate (%) and a discharge capacity retention rate at the time of repeating discharge 300 times are shown in Table 4.

TABLE 4
High-molecular compound: Polyvinylidene fluoride

| | | | | | Expansion rate | |
|---|---|---|---|---|---|---|
| | Halide | | FEC | VC | of battery after | |
| | | % by weight | % by weight | % by weight | storing at 90° C. | Retention rate |
| | | (based on the | (based on the | (based on the | for 4 hours | after 300 cycles |
| | Kind | solvent) | solvent) | solvent) | (%) | (%) |
| Example 4-1 | Molybdenum(V) chloride | 0.10 | 1.0 | 0 | 8 | 86.2 |
| Example 4-2 | Molybdenum(V) chloride | 0.05 | 1.0 | 0 | 16 | 84.3 |
| Example 4-3 | Molybdenum(V) chloride | 0.50 | 1.0 | 0 | 8 | 83.6 |
| Example 4-4 | Molybdenum(V) chloride | 0.10 | 0 | 1.0 | 8 | 87.4 |
| Example 4-5 | Zirconium(IV) chloride | 0.10 | 1.0 | 0 | 11 | 84.7 |
| Example 4-6 | Vanadium(III) chloride | 0.10 | 1.0 | 0 | 21 | 83.6 |
| Example 4-7 | Niobium(V) chloride | 0.10 | 1.0 | 0 | 10 | 83.7 |
| Example 4-8 | Tantalum(V) chloride | 0.10 | 1.0 | 0 | 10 | 83.6 |
| Example 4-9 | Tungsten(VI) chloride | 0.10 | 1.0 | 0 | 10 | 84.5 |
| Example 4-10 | Zinc(II) chloride | 0.10 | 1.0 | 0 | 8 | 83.7 |
| Example 4-11 | Aluminum(III) chloride | 0.10 | 1.0 | 0 | 9 | 83.9 |
| Example 4-12 | Gallium(III) chloride | 0.10 | 1.0 | 0 | 8 | 83.8 |
| Example 4-13 | Indium(III) chloride | 0.10 | 1.0 | 0 | 18 | 83.6 |
| Example 4-14 | Silicon(IV) chloride | 0.10 | 1.0 | 0 | 13 | 84.0 |
| Example 4-15 | Germanium(IV) chloride | 0.10 | 1.0 | 0 | 13 | 83.9 |
| Example 4-16 | Tin(VI) chloride | 0.10 | 1.0 | 0 | 18 | 83.6 |
| Example 4-17 | Phosphorus(V) chloride | 0.10 | 1.0 | 0 | 9 | 83.6 |
| Example 4-18 | Antimony(V) chloride | 0.10 | 1.0 | 0 | 17 | 83.6 |
| Comparative | Nil | 0 | 1.0 | 0 | 23 | 82.3 |
| Example 4-1 | | | | | | |

As shown in Table 4, in Example 4-1 containing molybdenum chloride and FEC in the electrolytic solution, the expansion rate of the battery was reduced by 15%, and the discharge capacity retention rate after 300 cycles was enhanced as compared with Comparative Example 4-1 containing FEC but not containing molybdenum chloride in the electrolytic solution. That is, it was noted that the joint use of FEC and a halide are excellent in the effect for suppressing the expansion of the battery and the discharge capacity retention rate as compared with the single use of FEC.

Also, the results reveal that Example 3-1 containing only molybdenum chloride is excellent in both the effect for suppressing the expansion rate of the battery and the discharge capacity retention rate as compared with Comparative Example 4-1 containing only FEC. That is, it was noted that the halide is excellent in the effect for suppressing the expansion of the battery and the discharge capacity retention rate as compared with FEC.

Also, in Example 4-2 in which the blending amount of molybdenum chloride is smaller than that in Example 4-1, though the results reveal that the expansion rate is higher than that in Example 4-1, the expansion rate could be reduced as compared with Comparative Example 4-1 not blending molybdenum chloride. On the other hand, in Example 4-3 in which the blending amount of molybdenum chloride is larger than that in Example 4-1, the expansion rate was in the same degree. That is, it was noted that when used jointly with FEC, the optimal content of the halide is from 0.02 to 0.50% by weight.

In Example 4-4 using VC in place of FEC, though the expansion rate was slightly lower than that in Example 4-1, the discharge capacity retention rate after 300 cycles was enhanced as compared with Example 4-1.

In all of Examples 4-5 to 4-18 in which the halide was changed, the expansion rate of the battery could be reduced, and the discharge capacity retention rate after 300 cycles was enhanced as compared with Comparative Example 4-1 not containing a halide. That is, it was noted that even by blending a chloride of an element selected from group consisting of Zr and elements belongings to the Group 5, the Group 6 and the Groups 12 to 15 of the Periodic Table other than molybdenum chloride in the electrolytic solution, the expansion of the battery at the time of high-temperature storage is suppressed, and the cycle characteristic is enhanced.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The application is claimed as follows:

1. A non-aqueous electrolytic solution secondary battery comprising:
a positive electrode;
a negative electrode; and
a non-aqueous electrolytic solution, wherein
the non-aqueous electrolytic solution contains a halide of an element selected from the group consisting of Zr and Group 5, Group 6 and Groups 12 to 15 of the Periodic Table.

2. The non-aqueous electrolytic solution secondary battery according to claim 1, wherein a concentration of the halide in the non-aqueous electrolytic solution is from 0.02 to 0.50% by weight.

3. The non-aqueous electrolytic solution secondary battery according to claim 1, wherein the halide is a chloride.

4. The non-aqueous electrolytic solution secondary battery according to claim 1, wherein the element is selected from the group consisting of Group 6 and Group 13 of the Periodic Table.

5. The non-aqueous electrolytic solution secondary battery according to claim 1, wherein the element is molybdenum.

6. The non-aqueous electrolytic solution secondary battery according to claim 1, wherein the non-aqueous electrolytic solution further contains a carbonic ester.

7. The non-aqueous electrolytic solution secondary battery according to claim 1, wherein the positive and negative electrodes and the non-aqueous electrolytic solution are contained in an exterior member made of a laminated film.

8. The non-aqueous electrolytic solution secondary battery according to claim 1, containing a high-molecular compound which is swollen by the non-aqueous electrolytic solution.

9. The non-aqueous electrolytic solution secondary battery according to claim 8, wherein the high-molecular compound is polyvinylidene fluoride.

10. A non-aqueous electrolytic solution comprising a halide of an element selected from the group consisting of Zr and Group 5, Group 6 and Groups 12 to 15 of the Periodic Table.

11. The non-aqueous electrolytic solution according to claim 10, wherein a concentration of the halide in the non-aqueous electrolytic solution is from 0.02 to 0.50% by weight.

12. The non-aqueous electrolytic solution according to claim 10, wherein the halide is a chloride.

13. The non-aqueous electrolytic solution according to claim 10, wherein the element is selected from the group consisting of Group 6 and Group 13 of the Periodic Table.

14. The non-aqueous electrolytic solution according to claim 10, wherein the element is molybdenum.

15. The non-aqueous electrolytic solution according to claim 10, further containing a carbonic ester.
